(19) United States
(12) Patent Application Publication
(10) Pub. No.: US 2006/0248730 A1
(43) Pub. Date: Nov. 9, 2006

(54) Tile nippers

(76) Inventors: Jon Miller, Fullerton, CA (US); Norman C. Tracy, Huntington Beach, CA (US); Norman L. Hill, Riverside, CA (US)

Correspondence Address: FULWIDER PATTON, 6060 CENTER DRIVE, 10TH FLOOR, LOS ANGELES, CA, 90045, US

(21) Appl. No.: 11/125,845

(22) Filed: May 9, 2005

(51) Int. Cl. B26B 17/00

(52) U.S. Cl. 30/175

(57) ABSTRACT

Tile nippers are provided with hardened teeth formed with a short radius curvature extending from substantially flat interior shoulders configured to be substantially parallel when used for gripping and breaking tile. A compound leverage assembly connects the jaws of the tile nippers to the handles of the tile nippers. A retractable cutter or scoring wheel may be provided in a free end of a handle. A nail puller notch may be provided on a jaw of the tile nippers to allow the tile nippers to be used for gripping and pulling nails without damaging the tips of the teeth.

### BACKGROUND OF THE INVENTION

1. Field of the Invention

This invention relates to hand operated cutting tools, and more particularly relates to tile nippers for cutting or breaking of tiles such as hard ceramic tiles.

2. General Background and State of the Art

Tile nippers are used for making a quick, rough cut, typically for an area that will not be exposed. Older types of ceramic tiles were traditionally formed with a thin glaze over a softer clay or terra cotta main body. However, more modem tiles are frequently made of harder materials, such as hard vitreous dense tile, quarry tile, cement tile, and porcelain tile, in which the entire tiles are hard, so that tile nippers increasingly tend to fail due to the hardness of new tiles. The tips of tile nippers are also commonly misused for pulling nails, which further contributes to the failure of the tile nippers.

Conventional tile nippers commonly have pointed teeth for piercing tile, and for irregular cutting of small bits of a tile to achieve a desired general shape. The tile nipper teeth typically have hard, sharp tips, with flat interior shoulders extending at an oblique angle in line with the bevel of the teeth for gripping and breaking tile, by torquing by the user of a gripped portion of the tile about a score line at the point of the teeth. However, usually considerable rotation of the nippers about the tile is required before the gripped portion of the tile is engaged by the shoulder portion of the teeth, placing greater stress on the tips of the teeth, and resulting in considerable follow-through shock to the hand of the user. It would therefore be desirable to provide more robust tile nippers that have strengthened teeth, with substantially parallel flat interior shoulders for gripping and breaking tile. It would also be desirable to make the tile nippers more ergonomic to reduce the transmission of shock to the hand of the user due to use of the tile nippers for making small bites in tile or breaking tile. It would also be desirable to provide improved compression and strength of the teeth to improve accuracy and precision of the tile nippers for finer detail work and reduced destruction of tiles. It would also be desirable to provide a retractable cutter or scoring wheel to provide the user the option of scoring tile for finer detail cutting of tile. It would also be desirable to adapt the tips of the teeth of tile nippers to be capable of being used for pulling nails without damaging the tips of the teeth. The present invention addresses these and other needs.

### INVENTION SUMMARY

Briefly, and in general terms, the invention provides for improved tile nippers with more robust carbide tipped teeth, formed with a short radius curvature extending from substantially flat interior shoulders that are configured to be substantially parallel when used for gripping and breaking tile. The tile nippers also have handles with an ergonomically improved compound leverage action, allowing for the application of greater compressive force, and resulting in reduced transmission of shock forces to the hand of the user. The combination of the compound action handles and strengthened teeth allows for improved accuracy and precision of the tile nippers in finer detail work, and results in reduced destruction of tiles. The tile nippers of the invention also may include a retractable or fixed cutter or scoring wheel to allow optional scoring of tile for precision breaking and cutting of tiles. In an alternate embodiment, the present invention also provides for a nail puller notch formed on a jaw of the tile nippers, for gripping and pulling nails without damaging the tips of the teeth.

The present invention accordingly provides for tile nippers for cutting tile, the tile nippers including first and second jaws, each of the first and second jaws having a tooth portion, a tang portion, and a jaw support portion intermediate the tooth portion and the tang portion. In a preferred aspect, the tooth portions each have hardened tips, which may be formed of carbide, such as tungsten carbide or titanium carbide. The jaws are pivotally connected together by a pivot assembly which extends through the jaw support portions of the jaws.

In another preferred aspect, the tooth portions are formed with a short radius curvature extending from substantially flat interior shoulder portions that are configured to be substantially parallel when the tips are adjacent to each other in a tile gripping position, such as for use in gripping and breaking tile. In one presently preferred option, a notch may be formed in one or both of the tooth portions, to allow the jaws to be used for gripping and pulling the shafts of nails or other fasteners.

The tile nippers also include first and second handles each having a free end and a connector end. The connector ends of the handles preferably include a compound leverage assembly pivotally connecting the connector ends of the handles together and pivotally connecting the handles to the tang portions of the jaws. In a presently preferred aspect, the connector portion of each handle is formed in a U-shaped configuration, with a first planar portion having a distal end and a medial portion, and a second planar portion having a distal end and a medial portion, with the first and second planar portions being connected by a middle portion. In one aspect, a handle pivot screw extends through mounting holes in the distal ends of the first and second planar portions of the handles to pivotally connect the handles together at their connector ends. The tang portions of the jaws are pivotally connected to the medial portions of the first and second planar portions of the connector ends of the handles. In another presently preferred aspect, a coiled handle spring is coiled around the handle pivot screw, with distal ends extending within the handles between the connecting screws and the medial portions of the handles, to bias the handles to an open position in which the free ends of the handles are spread apart, while allowing the handles to be manually squeezed together to bring the jaws of the tile nippers together.

The free ends of the handles may be covered by handle grips, which may be cast or molded plastic, for example. A cutter or scoring wheel may also be mounted to a free end of one or both of the handles. In a preferred aspect, the cutter or scoring wheel may be retractable into the handle to which it is mounted, or the cutter or scoring wheel may be detachable, with a fixed position when inserted in a handle of the tile nippers.

Other features and advantages of the present invention will become more apparent from the following detailed description of the preferred embodiments in conjunction with the accompanying drawings, which illustrate, by way of example, the operation of the invention.

### BRIEF DESCRIPTION OF THE DRAWINGS

FIG. 1 is a top plan view of the tile nippers according to the invention.

FIG. 2 is a side view of the tile nippers of FIG. 1.

FIG. 3 is a bottom view of the tile nippers of FIG. 1.

FIG. 4 is an enlarged view of the teeth of the jaws of the tile nippers from FIG. 1.

FIG. 5 is a perspective view of the tile nippers of FIG. 1.

FIG. 6 is a sectional view of the cutter or scoring wheel mounted to a free end of a handle of the tile nippers, shown in an extended position.

FIG. 7 is a sectional view of the cutter or scoring wheel of FIG. 6, shown in a retracted position in the handle of the tile nippers.

FIG. 8 is a cross-sectional view of a handle of the tile nippers taken along line 8-8 of FIG. 1.

FIG. 9 is a perspective view of a portion of the handle of FIG. 8.

FIG. 10 is an enlarged view of the pivot assembly and compound leverage assembly of the tile nippers of FIG. 1.

FIG. 11 is a fragmentary perspective view of the jaws and thumb latch of the tile nippers of FIG. 1.

FIG. 12 is a fragmentary perspective view of the jaws, thumb latch and a handle of the tile nippers of FIG. 1.

FIG. 13 is a top plan view of the tile nippers of FIG. 1 with a variation of the thumb latch and a detachably mounted fixed cutter or scoring wheel.

FIG. 14 is a side view of the tile nippers of FIG. 13.

FIG. 15 is a bottom view of the tile nippers of FIG. 13.

FIG. 16 is a perspective view of the detachable cutter or scoring wheel of FIG. 13.

FIG. 17 is a perspective view of the tile nippers of FIG. 13, showing the mounting of the detachable cutter or scoring wheel.

FIG. 18 is a front perspective view of a first variation of the jaws of the tile nippers of the invention having a nail puller notch.

FIG. 19 is an exploded top plan view of the jaws of the tile nippers of FIG. 18.

FIG. 20 is an exploded bottom plan view of the jaws of the tile nippers of FIG. 18.

FIG. 21 is a rear perspective view of a second variation of the jaws of the tile nippers of the invention having a nail puller notch.

FIG. 22 is a front perspective view of the tile nippers jaws of FIG. 21.

FIG. 23 is a front perspective view of a third variation of the jaws of the tile nippers of the invention having a nail puller notch.

FIG. 24 is a rear perspective view of the tile nippers jaws of FIG. 23.

FIG. 25 is a front perspective view of a fourth variation of the jaws of the tile nippers of the invention having a nail puller notch.

FIG. 26 is a rear perspective view of the tile nippers jaws of FIG. 25.

### DETAILED DESCRIPTION OF THE PREFERRED EMBODIMENTS

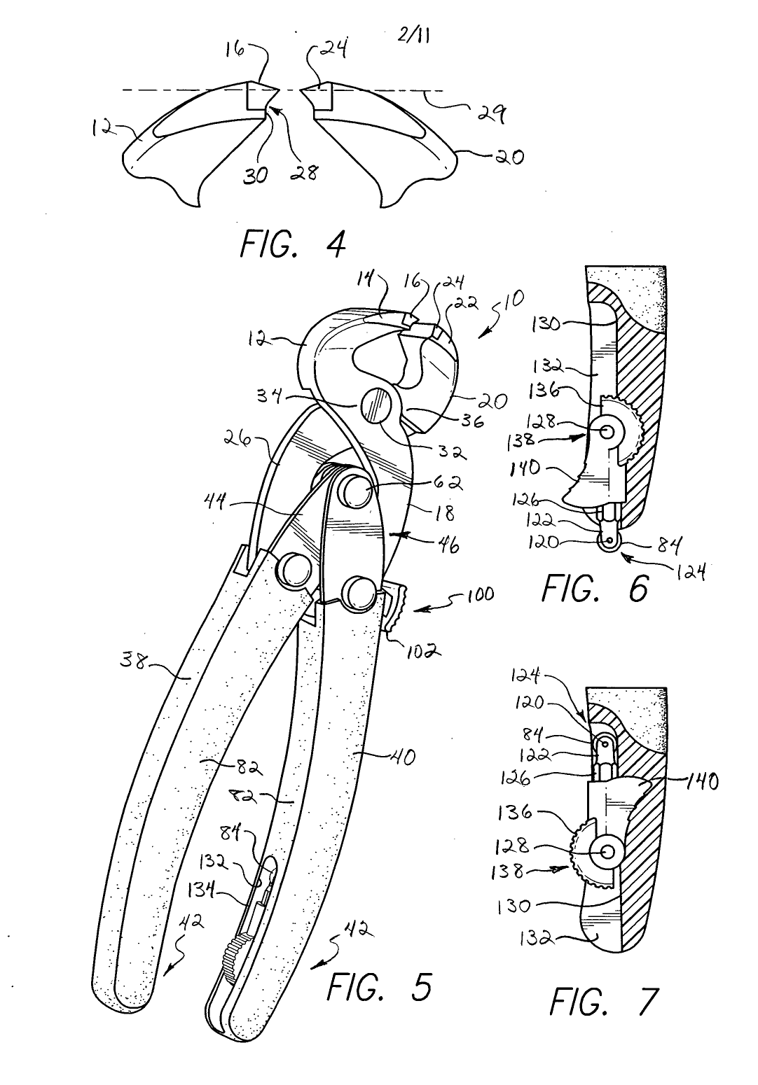

Referring to the drawings, which are provided by way of example, the present invention provides for tile nippers 10 having a first jaw 12 with a first tooth portion 14, a first hardened tip 16, and a first tang portion 18, as is illustrated in FIGS. 1 and 3. The tile nippers also include a second jaw 20 with a second tooth portion 22, a second hardened tip 24, and a second tang portion 26. Referring to FIG. 4, each of the hardened tips of the tooth portions are preferably formed of carbide, such as tungsten carbide or titanium carbide, for example, and are formed with a short radius curvature 28 extending from substantially flat interior shoulder portions 30 that are substantially perpendicular to the angle of attack of the tips and the axis 29 through the tips, and are configured to be substantially parallel when the tips are pressed together so as to be adjacent to each other in a tile gripping position as shown in FIG. 1, for example, such as for use in gripping tile and breaking the tile once the tile has been pierced by the tips. The first and second jaws are pivotally connected together by a pivot assembly 32 which extends through jaw support portions 34, 36 of the jaws.

The tile nippers include a pair of handles 38 and 40 typically formed of sheet metal bent in a U-shaped configuration, for example, although the handles may also be formed of stamped or forged metal. Each handle has a free end 42 and a connector end 44, with the connector ends of the handles including a compound leverage assembly 46 pivotally connecting the handles together and connecting the connector ends of the handles to the first and second tang portions of the jaws.

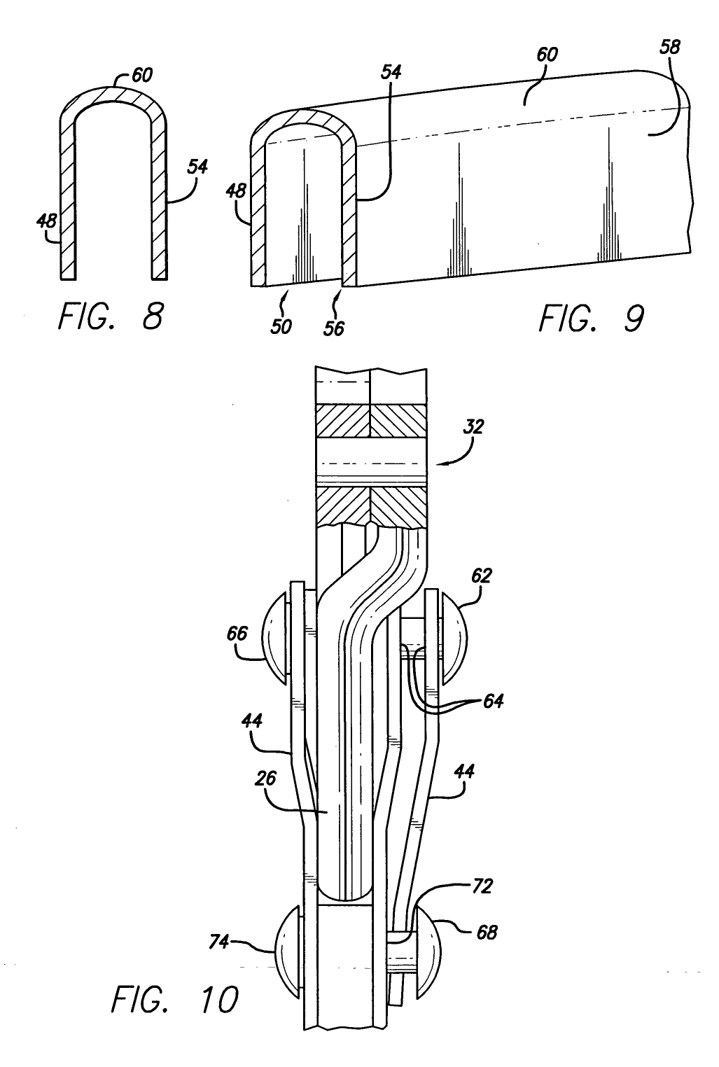

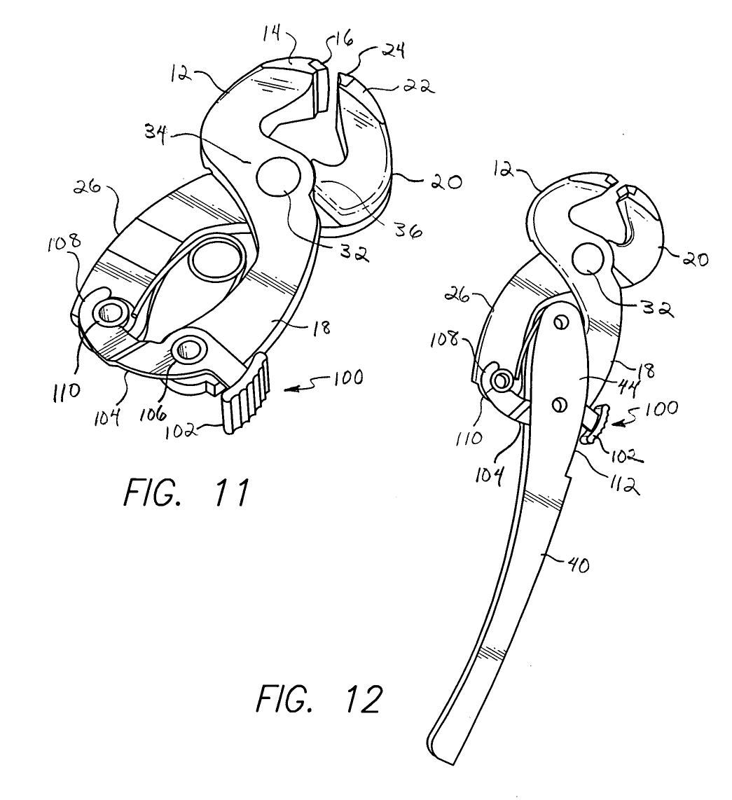

Referring to FIGS. 8 and 9, each handle is typically formed from metal or plastic in a U-shaped configuration, with a first planar portion 48 having a distal end 50 and a medial portion (not shown), and a second planar portion 54 having a distal end 56 and a medial portion 58, with the first and second planar portions being connected by a middle portion 60. The connector portion 44 is preferably slotted to receive the tangs of the jaws and a thumb latch, as will be further described below. As is shown in FIG. 10, a handle pivot pin 62 extends through mounting holes 64 in the distal ends of the first and second planar portions of the handles to pivotally connect the handles together at their distal ends. A locknut 66 secures the handle pivot screw to the handles. The first and second tang portions are pivotally connected to the medial portions of the first and second planar portions of the handles by connecting screws 68 and 70 extending through mounting holes 72 in the medial portions of the first and second planar portions of the handles, respectively, and secured by locknuts 74.

Referring to FIGS. 1 and 3, a coiled handle spring 76 may also be coiled around the handle pivot screw, with distal ends 78, 80 extending within the connector ends of the handles, to bias the handles to an open position in which the free ends of the handles are spread apart, while allowing the handles to be manually squeezed together to bring the jaws of the tile nippers together. The free ends of the handles may be covered by cast or molded plastic handle grips 82.

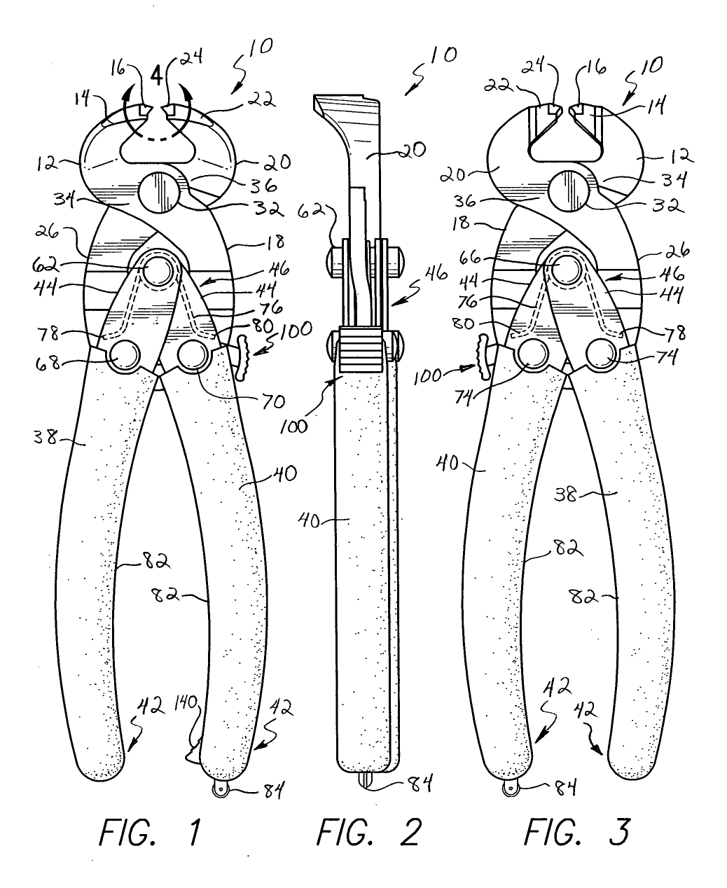

As is illustrated in FIGS. 1-3, a cutter or scoring wheel 84 may also be mounted to a free end of one of the handles. In one aspect, the cutter or scoring wheel may be rotatable or retractable into the handle to which it is mounted. In another variation illustrated in FIGS. 16 and 17, the cutter or scoring wheel 86 may be detachably mounted in a fixed position when inserted in a handle of the tile nippers, as will be further described below.

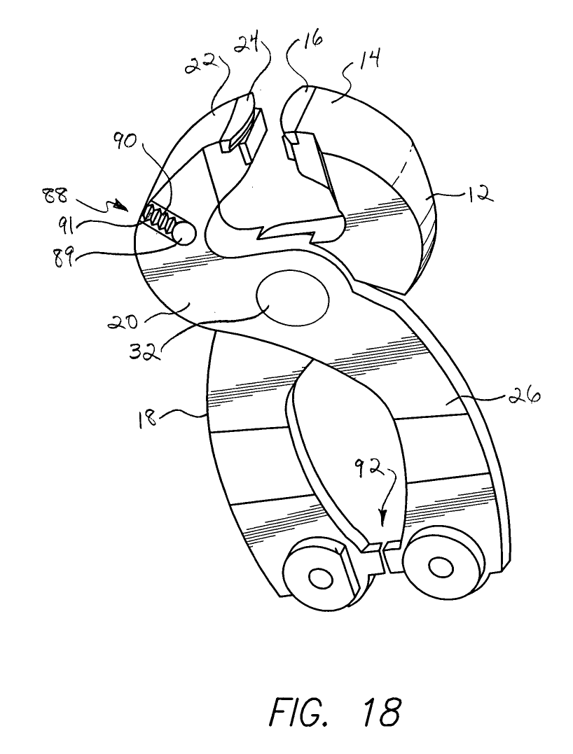

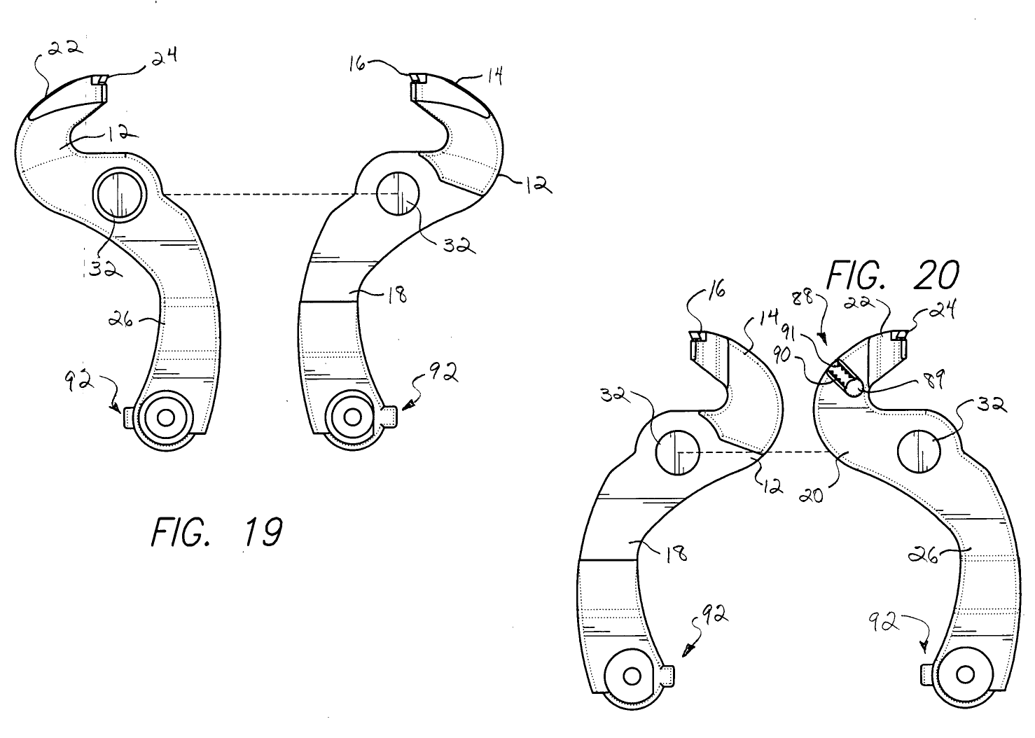

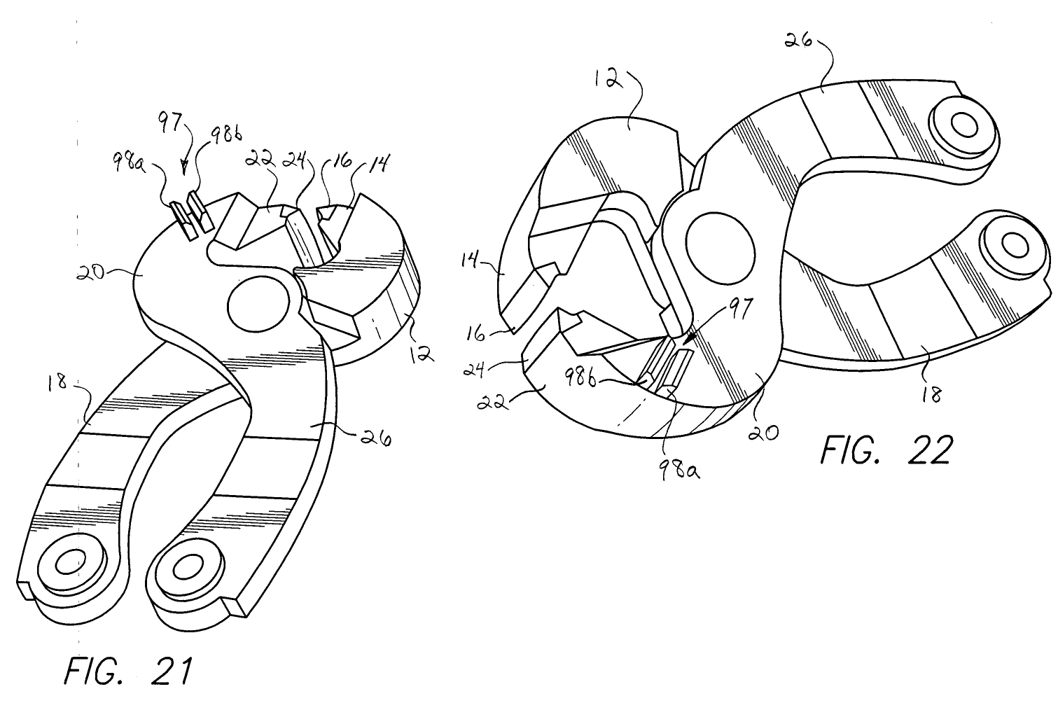

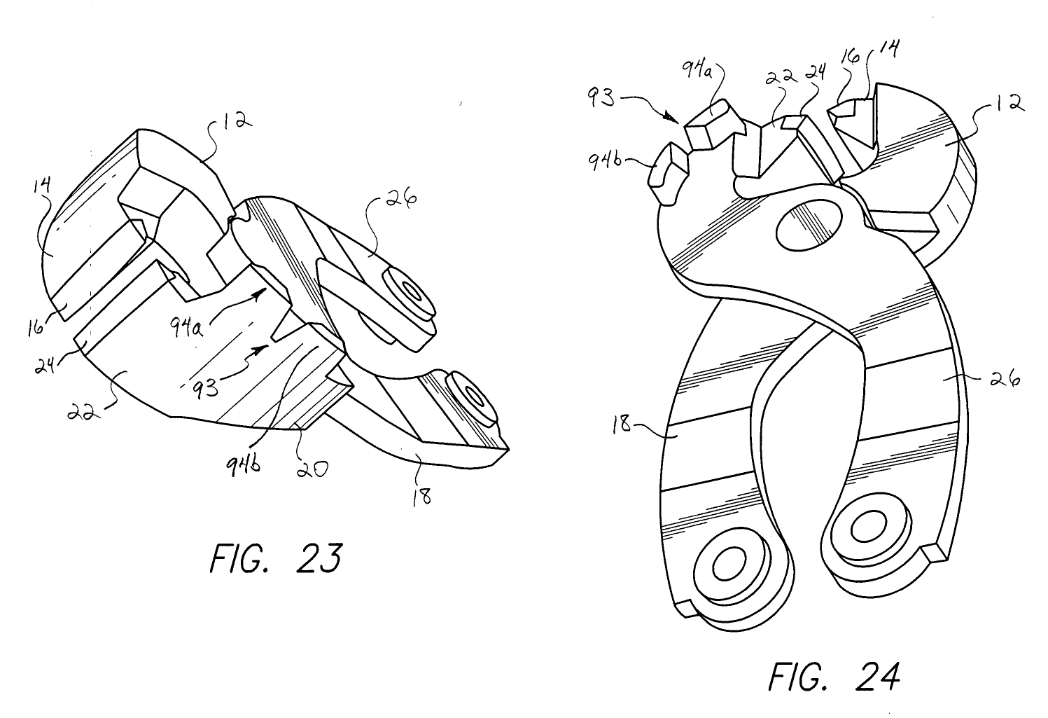

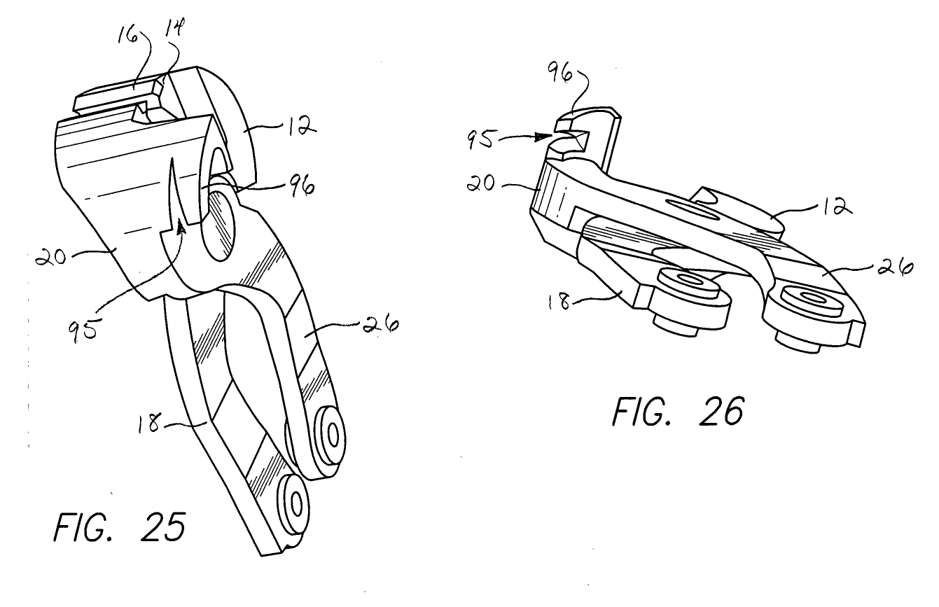

As is illustrated in FIGS. 18-20, in a presently preferred variation a nail puller notch, such as a recessed groove 88 having a rounded aperture 89 for receiving a head of a nail, and a narrowed edge portion forming a channel 90 connected to the rounded aperture and having a series of ridges and valleys 91 for receiving the shaft of the nail and releasably capturing the head of the nail, to allow the tile nippers to be used for gripping and pulling the shafts of nails or other fasteners. The inner end portions of the tang portions 18, 26 of the jaws may also be formed to include abutting spacer flanges 92 for limiting the depth to which the teeth of the jaws of the tile nippers will bite into tile. In another variation illustrated in FIGS. 23-24, a nail puller notch 93, such as a V-shaped notch, may be formed to extend laterally between two flanges 94a, 94b extending laterally from a side of a jaw, to allow the tile nippers to be used for gripping and pulling the shafts of nails or other fasteners. Optionally, as shown in FIGS. 25-26, the nail puller notch may be formed as a longitudinally oriented V-shaped notch 95 in a single flange 96 extending laterally from a side of a jaw. In another option illustrated in FIGS. 21-22, a nail puller notch 97 may be formed as an appropriately sized slot between two flanges 98a,b extending laterally from a side of a jaw.

Referring to FIGS. 1-3, 5, 11 and 12, in a presently preferred embodiment, the tile nippers include a thumb latch 100 having a generally flat handle portion 102 oriented transversely to a plane through the jaws of the tile nippers so as to be readily accessible to be pressed by a user to unlatch the jaws of the tile nippers. The thumb latch handle portion is connected to a latching arm 104 pivotally connected to a tang portion 18 of a jaw, typically mounted to pivot about a spindle or shaft 106 on the tang portion. The latching arm includes a hook or latching free end portion 108 that latches about a spindle or shaft 110 on the tang portion 26 of the other jaw. The handle connector portion 44 is preferably slotted to allow pivotal movement of the thumb latch through the slot 112 of the connector portion of the handle.

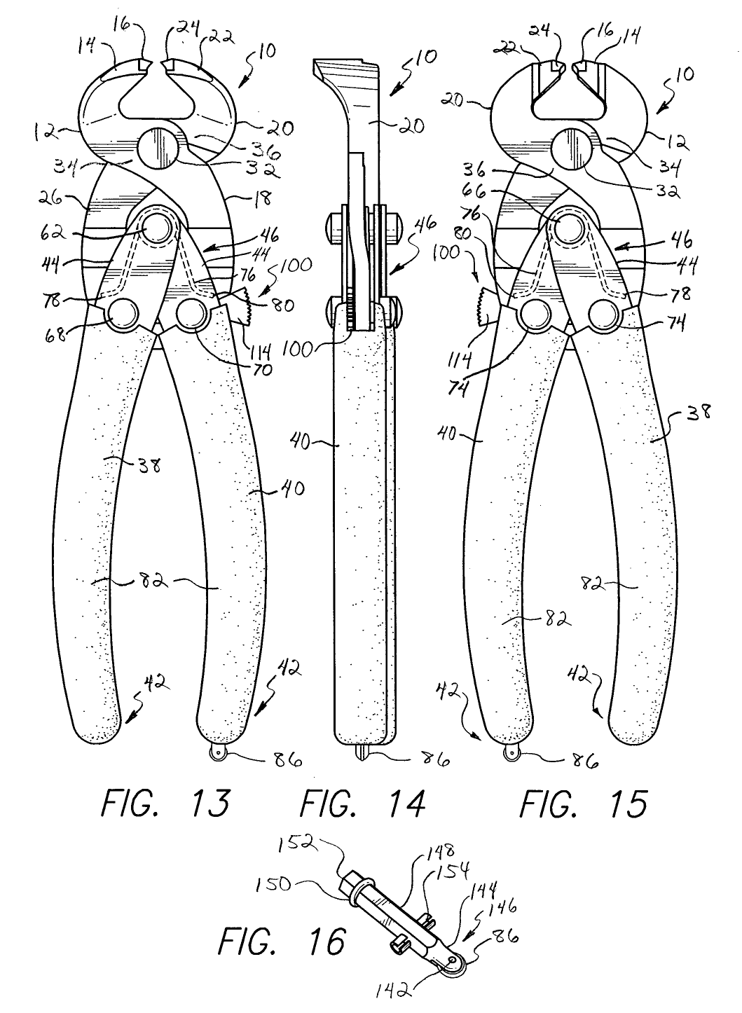

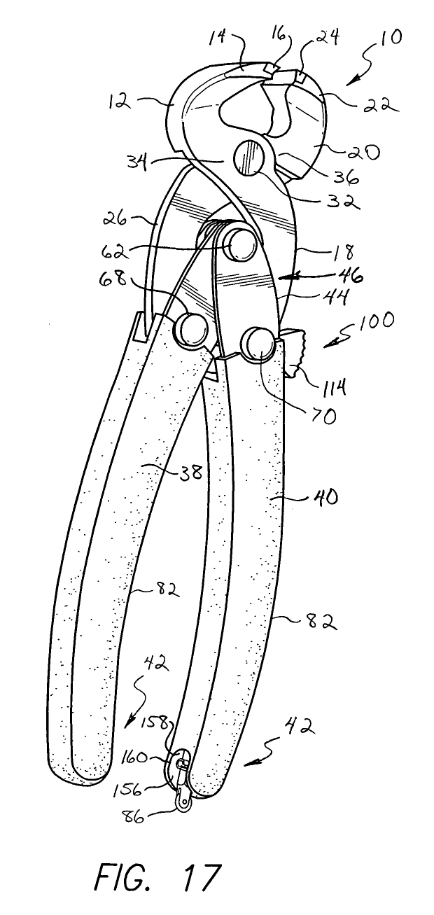

As is illustrated in FIGS. 13-15 and 17, in one variation, the thumb latch handle portion 114 may be oriented generally parallel to a plane through the jaws of the tile nippers, so as to be readily accessible to be pressed by a user to unlatch the jaws of the tile nippers.

Referring to FIGS. 1-3 and 5-7, in one presently preferred embodiment, the cutter or scoring wheel is mounted for rotation about a wheel pin 120 in a wheel mount 122 at the free end 124 of a pivot arm 126. The pivot arm is pivotally mounted for rotation about a pivot pin 128 in a recess 130 of the handle and having an opening 132 in the free end of a handle. The handle grip for the handle also has a corresponding cutout portion or opening 134 matching the opening of the recess of the handle. The pivot arm advantageously includes a thumb wheel 136 adjacent to the pivoting end 138 of the pivot arm to allow a user to rotate the cutter or scoring wheel from a retracted position shown in FIGS. 5 and 7 out of the recess to an extended position extending from the free end of the handle, as shown in FIG. 6. The pivot arm also preferably includes a flange 140 allowing a user to push on the flange to rotate the cutter or scoring wheel from the extended position to a retracted, recessed position in the recess of the handle.

As is illustrated in FIGS. 13-17, the tile nippers may include a detachably mountable cutter or scoring wheel 86, with a fixed position when mounted. The detachable cutter or scoring wheel is mounted for rotation about a wheel pin 142 in a wheel mount 144 at an end 146 of a cutter bar 148. Referring to FIG. 17, the cutter bar includes an O-ring seated at the other end 152 of the cutter bar, to facilitate seating of the cutter bar in a longitudinal cutter bar recess 156 in the handle. When the cutter bar is seated in the cutter bar recess, the cutter or scoring wheel extends from the free end of the handle, and a tubular pin 154 extending transversely through the cutter bar extends outwardly in the cutter bar recess opening 158 in the handle and the corresponding opening 160 in the handle grip, to allow a user to more easily grip, attach and detach the detachable cutter or scoring wheel.

It will be apparent from the foregoing that while particular forms of the invention have been illustrated and described, various modifications can be made without departing from the spirit and scope of the invention. Accordingly, it is not intended that the invention be limited, except as by the appended claims.

I claim:

1. Tile nippers for cutting tile, comprising:
a first jaw having a first tooth portion, a first tang portion, and a first jaw support portion intermediate the first tooth portion and the first tang portion;
a second jaw having a second tooth portion, a second tang portion, and a second jaw support portion intermediate the second tooth portion and the second tang portion;
a pivot assembly extending through the first and second jaw support portions to pivotally connect the first and second jaws together; and
first and second handles each having a free end and a connector end, the connector ends of the handles including a compound leverage assembly pivotally connecting the connector ends of the handles together and pivotally connecting the connector ends of the handles to the first and second tang portions of the jaws.

2. The tile nippers of claim 1, wherein said first tooth portion comprises a first hardened tip, and said second tooth portion comprises a second hardened tip.

3. The tile nippers of claim 1, wherein said first and second hardened tip are formed of carbide.

4. The tile nippers of claim 1, wherein said first and second tooth portions are each formed a substantially flat interior shoulder portion, and hardened tips having a short radius curvature extending from said substantially flat interior shoulder portions.

5. The tile nippers of claim 4, wherein said first and second tooth portions are configured such that said substantially flat interior shoulder portions are substantially parallel when the tips are adjacent to each other.

6. The tile nippers of claim 1, wherein at least one of the jaws includes a nail puller notch.

7. The tile nippers of claim 1, wherein the connector portion of each handle is formed in a U-shaped configuration, with a first planar portion having a distal end and a medial portion, and a second planar portion having a distal end and a medial portion, with the first and second planar portions being connected by a middle portion.

8. The tile nippers of claim 7, wherein the distal ends of each of said first and second planar portions include mounting holes, and a handle pivot screw extends through said mounting holes to pivotally connect the connector ends of the handles together.

9. The tile nippers of claim 7, wherein the medial portions of the first and second planar portions of the handles include mounting holes, and said first and second tang portions are pivotally connected to the medial portions of the first and second planar portions of the handles by connecting screws extending through the mounting holes in the medial portions of the first and second planar portions of the handles, respectively.

10. The tile nippers of claim 9, further comprising a coiled handle spring is coiled around the handle pivot screw, the coiled handle spring having distal ends extending within the handles to bias the handles to an open position in which the free ends of the handles are spread apart, while allowing the handles to be manually squeezed together to bring the teeth of the tile nippers toward each other.

11. The tile nippers of claim 1, wherein said free ends of the handles are covered by handle grips.

12. The tile nippers of claim 1, wherein a scoring wheel is mounted to the free end of at least one of said handles.

13. The tile nippers of claim 12, wherein said scoring wheel is rotatably movable into and out of the free end of said at least one of said handles.

14. The tile nippers of claim 12, wherein said scoring wheel is detachably mounted to the free end of said at least one of said handles.

15. Tile nippers for cutting tile, comprising:
a first jaw having a first tooth portion with a hardened tip, a first tang portion, and a first jaw support portion intermediate the first tooth portion and the first tang portion;
a second jaw having a second tooth portion with a hardened tip, a second tang portion, and a second jaw support portion intermediate the second tooth portion and the second tang portion;
a pivot assembly extending through the first and second jaw support portions to pivotally connect the first and second jaws together; and
first and second handles each having a free end and a connector end, the connector ends of the handles including a compound leverage assembly pivotally connecting the connector ends of the handles together and pivotally connecting the connector ends of the handles to the first and second tang portions of the jaws.

16. The tile nippers of claim 15, wherein said first and second hardened tip are formed of carbide.

17. The tile nippers of claim 15, wherein said first and second tooth portions are each formed a substantially flat interior shoulder portion, and hardened tips having a short radius curvature extending from said substantially flat interior shoulder portions.

18. The tile nippers of claim 17, wherein said first and second tooth portions are configured such that said substantially flat interior shoulder portions are substantially parallel when the tips are pressed adjacent to each other.

19. The tile nippers of claim 15, wherein at least one of the jaws includes a nail puller notch.

20. The tile nippers of claim 15, wherein said free ends of the handles are covered by handle grips.

21. The tile nippers of claim 15, wherein a scoring wheel is rotatably mounted to the free end of at least one of said handles.

22. The tile nippers of claim 21, wherein said scoring wheel is detachably mounted to the free end of at least one of said handles.
